(19) United States
(12) Patent Application Publication
(10) Pub. No.: US 2024/0375086 A1
(43) Pub. Date: Nov. 14, 2024

(54) METAL OXIDE CATALYST FOR SELECTIVE CATALYTIC REDUCTION

(71) Applicant: BASF CORPORATION, Florham Park, NJ (US)

(72) Inventors: Dengsong ZHANG, Shanghai (CN); Penglu WANG, Shanghai (CN); Hongrui LI, Shanghai (CN); Yuejin LI, Iselin, NJ (US); Shau Lin CHEN, Shanghai (CN)

(21) Appl. No.: 18/684,531

(22) PCT Filed: Aug. 18, 2022
(86) PCT No.: PCT/CN2022/113350

§ 371 Date: Feb. 16, 2024

(30) Foreign Application Priority Data
Aug. 19, 2021 (CN) 202110952837.6
Aug. 19, 2021 (WO) PCT/CN2021/113508

(51) Int. Cl. B01J 23/34; B01J 21/06; B01J 23/745; B01J 23/76; B01J 35/00; B01J 35/30; B01J 37/02; F01N 3/035

(52) U.S. Cl. CPC B01J 23/34; B01J 21/063; B01J 23/745; B01J 23/76; B01J 35/19; B01J 35/393; B01J 37/0209; B01J 37/0215; F01N 3/035

(57) ABSTRACT

A non-vanadium based metal oxide catalyst composition is provided. The catalyst composition comprises at least one metal oxide, comprising manganese oxide and being dispersed on the support, and a support comprising particles of composite oxide of aluminum and at least one metal selected from cerium, manganese and titanium, wherein aluminum is present in the composite oxide in an amount of from 50% to 80% by weight, calculated as Al₂O₃, based on the total weight of the composite oxide, and wherein manganese oxide is present in the metal oxide catalyst composition in an amount of from 2.5% to 10% by weight, calculated as MnO₂, based on the total weight of the metal oxide catalyst composition.

### FIELD OF THE INVENTION

The present invention relates to a non-vanadium based metal oxide catalyst for selective catalytic reduction, a process for the preparation thereof, and a method for treatment of exhaust gases containing nitrogen oxides by selective catalytic reduction.

### BACKGROUND

Nitrogen oxides (NOx) are common air pollutants, which are generally contained in exhaust gases from mobile sources such as automobiles and stationary sources such as power plants. Control of NOx emission is always one of the most important topics for example in automobile manufacturing field, due to the environmentally negative impact of NOx on ecosystem, human beings, animals and plants.

Various treatment methods, for example catalytic reduction of nitrogen oxides, have been used to abate NOx in exhaust gases. One typical catalytic reduction process is selective catalytic reduction with ammonia (NH₃) or ammonia precursor as a reducing agent in the presence of atmospheric oxygen, which is also referred to as SCR process. The SCR process is considered superior since a high degree of NOx abatement can be obtained with a small amount of reducing agent. Typically, the nitrogen oxides and the reducing agent NH₃ are reacted in accordance with following equations:

4NO+4NH₃ +O₂→4N₂+6H₂O (standard SCR reaction)

2NO₂+4NH₃ +O₂→3N₂+6H₂O (slow SCR reaction)

NO+NO₂+2NH₃→2N₂+3H₂O (fast SCR reaction).

A side reaction accompanying the selective catalytic reduction is the formation of low-valent nitrogen oxides, especially nitrous oxide (N₂O) from the reductant NH₃ and oxygen.

NOx treatment efficacy with respect to for example NOx conversion and N₂O formation greatly depends on the catalyst used in an SCR process. Catalysts useful for the selective catalytic reduction of NOx, i.e., SCR catalysts, are well-known.

A typical class of SCR catalyst is vanadium-based catalyst, which generally comprises vanadium oxide as active species and optionally one or more other metal oxide as promoters such as WO₃, on a support such as TiO₂. However, the vanadium-based catalysts do not have desirable thermal durability. The vanadium-based catalysts, once being aged, will exhibit rather low activity under a low temperature (e.g., below 300° C.). Another drawback of vanadium-based catalysts is the possible escape of V₂O₅ to the ambient, causing an environmental concern.

Another class of SCR catalyst is zeolite-based catalyst, which generally comprises transition metal exchanged small-pore aluminosilicate zeolite. The zeolite-based catalysts exhibit high activity under a low temperature (e.g., 210° C.), which however has a drawback of slow response to reductant injection. It is believed that the slow response is due to the acid sites of the zeolite framework, where the reductant NH₃ will be absorbed to saturation before it is effectively available for NOx reduction.

Recently, a class of non-vanadium metal oxides has been proposed as alternatives to zeolite- based catalysts and vanadium-based catalysts for SCR. Those metal oxide catalysts generally comprise one or more oxides of base metal active species on a support, as described in some prior patent applications.

JP 2003326167A describes an SCR catalyst comprising tungsten oxide or molybdenum oxide on a zirconium-based support.

WO2009001131A describes an SCR catalyst comprising at least one transition metal dispersed on a mixed oxide or composite oxide or a mixture thereof as support material consisting of cerium and zirconium.

CN106824173A describes an SCR catalyst comprising manganese oxide (MnOx) dispersed on a composite oxide of cerium and aluminum (CeO₂-Al₂O₃) as a support. The support was prepared by coprecipitation of cerium and aluminum hydroxides and then calcination to obtain the composite oxide of cerium and aluminum.

It will be desirable if a non-vanadium based metal oxide SCR catalyst having improved NOx treatment efficiency could be developed.

### SUMMARY OF THE INVENTION

It is an object of the present invention to provide an SCR catalyst which performs well, especially under a low temperature (e.g., below 210° C.).

It has surprisingly been found that the object was achieved by a non-vanadium based metal oxide composition which comprises manganese (Mn) species dispersed on a support comprising particles of composite oxide of aluminum (Al) and at least one metal selected from cerium (Ce), manganese and titanium (Ti).

Another object of the present invention is to provide a process particularly useful for preparation of the non-vanadium based metal oxide composition with improved NOx treatment efficacy.

The object was achieved by a process comprising impregnation of a precursor of the Mn species onto the support comprising particles of composite oxide of aluminum and at least one metal selected from cerium, manganese and titanium in a water-soluble alcohol solvent.

Accordingly, in one aspect, the present invention relates to a non-vanadium based metal oxide catalyst composition, which comprises
at least one metal oxide, comprising manganese oxide, and
a support, comprising particles of composite oxide of aluminum and at least one metal selected from cerium, manganese and titanium, wherein aluminum is present in the composite oxide in an amount of from 50% to 80% by weight, calculated as Al₂O₃, based on the total weight of the composite oxide,
wherein the at least one metal oxide is dispersed on the support, and
wherein manganese oxide is present in the metal oxide catalyst composition in an amount of from 2.5% to 10% by weight, calculated as MnO₂, based on the total weight of the metal oxide catalyst composition.

In another aspect, the present invention relates to a process for preparing the non-vanadium based metal oxide catalyst composition as described herein, which comprises impregnating one or more precursors of the at least one metal oxide onto the support, particularly in a water-soluble alcohol solvent and calcinating.

In yet another aspect, the present invention relates to a method for treatment of exhaust gases containing nitrogen oxides by selective catalytic reduction, which comprises contacting the exhaust gas with the metal oxide catalyst composition as described herein in the presence of a reductant.

In a further aspect, the present invention relates to a system for treatment of exhaust gases, especially from an internal combustion engine, which comprises a reductant source, the metal oxide catalyst composition as described herein, and optionally one or more of diesel oxidation catalyst (DOC), three-way conversion catalyst (TWC), four-way conversion catalyst (FWC), non-catalyzed or catalyzed soot filter (CSF), ammonia oxidation catalyst (AMOx), NOx trap, NOx absorber catalyst, hydrocarbon trap catalyst, sensor and mixer.

It has been found by the inventors that the metal oxide catalyst composition according to the present invention has improved NOx treatment efficacy, especially useful for treating exhaust gases from automobile engines, particularly heavy-duty diesel engines. The metal oxide catalyst composition according to the present invention exhibits both good SCR performance under a low temperature (e.g., below 210° C.) and desirable thermal stability.

### BRIEF DESCRIPTION OF THE DRAWINGS

FIG. 1 shows XRD patterns of the fresh composite oxide support materials as used in Examples.

FIG. 2 shows XRD patterns of the aged composite oxide support materials as used in Examples.

### DETAILED DESCRIPTION OF THE INVENTION

The present invention will be described in detail hereinafter. It is to be understood that the present invention may be embodied in many different ways and shall not be construed as limited to the embodiments set forth herein.

Herein, the singular forms “a”, “an” and “the” include plural referents unless the context clearly dictates otherwise. The terms “comprise”, “comprising”, etc. are used interchangeably with “contain”, “containing”, etc. and are to be interpreted in a non-limiting, open manner. That is, e.g., further components or elements may be present. The expressions “consists of” or “consists essentially of” or cognates may be embraced within “comprises” or cognates.

The term “composite oxide” as used herein refers to an oxide material consisting of oxides of two or more elements, which can be identified as respective oxides and crystallographic phases by X-ray diffraction. The respective oxides are in intimate contact but are not a physical mixture of the oxides obtained by physical means, for example by mechanical mixing or blending.

The term “non-vanadium based” as used herein refers to a metal oxide catalyst composition which does not comprise any vanadium (e.g., in form of vanadia) intentionally incorporated into the composition. The term “non-vanadium based metal oxide catalyst composition” and term “metal oxide catalyst composition” will be used interchangeably with each other herein.

The term “catalytic article” as used herein is just intended to mean an item in a certain shape having the function of catalyst, which is not necessarily a single body. In other words, the catalytic article may be a single body or consist of two or more separatable bodies.

In first aspect, the present invention provides a non-vanadium based metal oxide catalyst composition, which comprises
at least one metal oxide, comprising manganese oxide, and
a support, comprising particles of composite oxide of aluminum and at least one metal selected from cerium, manganese and titanium, wherein aluminum is present in the composite oxide in an amount of from 50% to 80% by weight, calculated as Al₂O₃, based on the total weight of the composite oxide,
wherein the at least one metal oxide is dispersed on the support, and
wherein manganese oxide is present in the metal oxide catalyst composition in an amount of from 2.5% to 10% by weight, calculated as MnO₂, based on the total weight of the metal oxide catalyst composition.

The at least one metal oxide dispersed on the support may further comprises an oxide of titanium (Ti), iron (Fe), magnesium (Mg) or aluminum (Al), or any combinations thereof. Each of the oxides of Ti, Fe, Mg and Al, if present, may be comprised in the metal oxide catalyst composition according to the present invention in an amount of no greater than 10% by weight, no greater than 8% by weight, or no greater than 6% by weight, calculated as respective oxides, based on the total weight of the metal oxide catalyst composition.

In some embodiments, the at least one metal oxide dispersed on the support consists of manganese oxide, and manganese oxide is present in the metal oxide catalyst composition in an amount of from 2.5% to 10% by weight or 3% to 8% by weight, calculated as MnO₂, based on the total weight of the metal oxide catalyst composition.

In some embodiments, the at least one metal oxide dispersed on the support comprises or consists of manganese oxide and titanium oxide. It is preferred in those embodiments that manganese oxide is present in an amount of from 2.5% to 10% by weight or 3% to 8% by weight calculated as MnO2, and titanium oxide is present in an amount of 1 to 6% by weight, or 2 to 4% by weight calculated as TiO2, each based on the total weight of the metal oxide catalyst composition. Particularly, manganese oxide and titanium oxide may be present in a weight ratio of 1:1 to 3:1, or 1.2:1 to 2.5:1, or 1.5:1 to 2:1.

In some embodiments, the at least one metal oxide dispersed on the support comprises or consists of manganese oxide and iron oxide. It is preferred in those embodiments that manganese oxide is present in an amount of from 2.5% to 10% by weight or 3% to 8% by weight calculated as MnO2, and iron oxide is present in an amount of 1 to 5% by weight, or 3 to 5% by weight calculated as Fe203, each based on the total weight of the metal oxide 25 catalyst composition. Particularly, manganese oxide and iron oxide may be present in a weight ratio of 1:1 to 2:1, or 1:1 to 1.5:1.

In some further embodiments, the at least one metal oxide dispersed on the support comprises or consists of manganese oxide, titanium oxide and iron oxide. It is preferred in those embodiments that manganese oxide is present in an amount of from 2.5% to 10% by weight or 3% to 8% by weight calculated as MnO2, titanium oxide is present in an amount of 1 to 6% by weight, or 2 to 4% by weight calculated as TiO₂, and iron oxide is present in an amount of 1 to 5% by weight, or 3 to 5% by weight calculated as Fe₂O₃, each based on the total weight of the metal oxide catalyst composition.

The support is in form of particles on which the at least one metal oxide as described herein may be dispersed (also referred to as “supported”). The particles of the composite oxide may have a BET specific surface area of 50 to 200 m^{2/}g in fresh state.

The particles may have been modified by a dopant, for example Ti, Si, Zr, La or Ba. In this case, the support may comprise particles of the composite oxide and a dopant. The dopant may be present in an amount of 1 to 10% by weight, or 3 to 6% by weight calculated as respective oxides, based on the total weight of the metal oxide catalyst composition.

Herein, the term “modified” or “modifying” used within the context of the support refers to treating particles of the composite oxide to incorporate the dopant onto the particles. In other word, the dopant is not incorporated during the formation of the composite oxide.

In some embodiments, the support comprises or consists of particles of a composite oxide of aluminum, cerium and optionally manganese and/or titanium. Particularly, the support consists of particles of a composite oxide of aluminum and cerium, and optionally a dopant. The composite oxide of aluminum and cerium may comprise a phase of Al₂O₃, and a phase of CeO₂ with a crystallite size of at least 5 nm, preferably at least 9 nm, at least 9.5 nm or at least 10 nm, as determined by X-ray powder diffraction (XRD) analysis in fresh state. Cerium may present in the composite oxide in an amount of 20% to 50% by weight, 20% to 40% by weight, or 20% to 30% by weight, calculated as CeO₂, based on the total weight of the composite oxide.

The metal oxide catalyst composition according to the present invention may further comprises a coating metal oxide, for example titanium oxide, aluminum oxide, silicon oxide, magnesium oxide, zirconium oxide or any combinations thereof. The coating metal oxide may be useful for improving resistance of the catalyst to sulfur poisoning or improving the thermal stability of the catalyst.

Herein, the term “coating” refers to a component incorporated in the metal oxide catalyst composition by dispersing it or its precursor onto the surface of catalyst particles. The coating metal oxide, may be in form a gas permeable layer or partial layer or segregated islands on the surface of catalyst particles. The coating metal oxide may be incorporated on the catalyst by post treatment or by co-impregnation with active components.

The coating metal oxide may be present in the metal oxide catalyst composition in an amount of 0.5% to 10% by weight, 1% to 5% by weight, or 0.8 to 3% by weight based on the total weight of the metal oxide catalyst composition.

In case of that the metal oxide catalyst composition according to the present invention comprises titanium in two or more of the at least one metal oxide, the dopant and the coating metal oxide components, titanium may be present in an amount of no greater than 6% by weight in sum calculated as TiO₂, based on the total weight of the metal oxide catalyst composition.

In some embodiments, the metal oxide catalyst composition according to the present invention comprises titanium in just one of the at least one metal oxide, the dopant and the coating metal oxide components in respective amounts as described hereinabove.

In some illustrative embodiments, the metal oxide catalyst composition comprises
at least one metal oxide, comprising or consisting of manganese oxide, or manganese oxide and titanium oxide,
a support, comprising particles of composite oxide of aluminum and cerium and optionally a dopant, wherein cerium is present in the composite oxide in an amount of 20% to 40% by weight or 20% to 30% by weight, calculated as CeO₂, based on the total weight of the composite oxide,
wherein the at least one metal oxide is dispersed on the support, and
wherein manganese oxide is present in the metal oxide catalyst composition in an amount of from 2.5% to 10% by weight, calculated as MnO₂, based on the total weight of the metal oxide catalyst composition.

In some other illustrative embodiments, the metal oxide catalyst composition comprises
at least one metal oxide, consisting of manganese oxide, or manganese oxide and titanium oxide,
a support, comprising particles of composite oxide of aluminum and cerium and optionally a dopant, wherein cerium is present in the composite oxide in an amount of 20% to 40% by weight or 20% to 30% by weight, calculated as CeO₂, based on the total weight of the composite oxide,
wherein the at least one metal oxide is dispersed on the support, and
wherein manganese oxide is present in the metal oxide catalyst composition in an amount of from 3% to 8% by weight, calculated as MnO₂, based on the total weight of the metal oxide catalyst composition.

In some further illustrative embodiments, the metal oxide catalyst composition comprises
at least one metal oxide, consisting of manganese oxide, or manganese oxide and titanium oxide,
a support, comprising particles of composite oxide of aluminum and cerium and optionally a dopant, wherein cerium is present in the composite oxide in an amount of 20% to 40% by weight or 20% to 30% by weight, calculated as CeO₂, based on the total weight of the composite oxide,
wherein the at least one metal oxide is dispersed on the support,
wherein manganese oxide is present in the metal oxide catalyst composition in an amount of from 3% to 8% by weight, calculated as MnO2, based on the total weight of the metal oxide catalyst composition, and
wherein the composite oxide of aluminum and cerium may comprise a phase of Al₂O₃, and a phase of CeO₂ with a crystallite size of at least 9 nm, at least 9.5 nm or at least 10 nm, as determined by X-ray powder diffraction (XRD) analysis in fresh state.

The metal oxide catalyst composition may be prepared conventionally, for example by impregnation one or more precursors of the at least one metal oxide onto the support.

Accordingly, in the second aspect, the present invention provides a process for preparing the non-vanadium based metal oxide catalyst composition as described herein, which comprises a step of impregnating one or more precursors of the at least one metal oxide onto the support, preferably in a water-soluble alcohol solvent, and then optionally a step of impregnating one or more precursors of the coating metal oxide.

Particularly, the present invention provides a process for preparing the non-vanadium based metal oxide catalyst composition as described herein, which comprises following steps
impregnating one or more precursors of the at least one metal oxide onto support particles in a water-soluble alcohol solvent, to obtain the supported particles,
calcining the supported particles, to obtain the calcined particles, and
optionally, impregnating one or more precursors of the coating metal oxide onto the calcined particles and then calcinating.

Suitable water-soluble alcohols as the solvent for impregnating one or more precursors of the at least one metal oxide may include, but are not limited to methanol, ethanol, n-propanol and iso-propanol.

The at least one metal oxide, the support and the coating metal oxide are as described hereinabove for the metal oxide catalyst composition. There is no particular restriction to the precursors of the at least one metal oxide and the coating metal oxide. The precursors may be inorganic or organic, soluble salt, complex or other compounds of the metals.

The support may comprise or consist of the particles of composite oxide as described hereinabove for the metal oxide catalyst composition in the first aspect. Particularly, the support consists of the particles of composite oxide and optionally a dopant such as Ti, Si, Zr, La or Ba, as described hereinabove for the metal oxide catalyst composition.

In case of that the support consists of the particles of composite oxide modified by a dopant, the modification may also be carried out by a process comprising impregnation of one or more precursors of the dopant onto the particles of composite oxide, preferably in a water- soluble alcohol solvent, drying and optionally calcining.

Accordingly, the process according to the present invention optionally comprises a step of impregnating one or more precursors of the dopant onto the particles of composite oxide, preferably in a water-soluble alcohol solvent, drying and optionally calcining, before impregnating one or more precursors of the at least one metal oxide.

In the process according to the present invention, the impregnating and calcining operations may be carried out in any conventional manners and conditions well-known in the art, except that a water-soluble alcohol solvent may be used for impregnating one or more precursors of the at least one metal oxide onto support particles.

In some embodiments, the impregnation of the precursors of the dopant and/or the coating metal oxide are also carried out in a water-soluble alcohol solvent.

As well-known in the art, the calcining steps in the process according to the present invention may be subsequent to a drying step.

It has been found that the metal oxide catalyst composition according to the present invention exhibits desirable thermal stability and improved NOx treatment efficacy, compared with conventional catalysts.

Without being bound to any theory, it is assumed that the thermal stability may be related to the distinct microcosmic structure of the composite oxide used as the support in the metal oxide catalyst composition. Additionally, it is believed that the improvement NOx treatment efficacy is related to the distinct composition of metal oxides as comprised, and may also related to the distinct microcosmic structure of the composite oxide.

It has also been surprisingly found that the catalysts prepared by impregnating one or more precursors of the at least one metal oxide onto support particles in a water-soluble alcohol solvent exhibit an improved NOx conversion, compared with catalysts prepared in the same manner except that water was used in place of the water-soluble alcohol as solvent.

In the third aspect, the present invention provides a method for treatment of exhaust gases containing nitrogen oxides by selective catalytic reduction, which comprises contacting the exhaust gas with the metal oxide catalyst composition as described herein, in the presence of a reductant.

The metal oxide catalyst composition may be used in any conventional forms in the method for treatment of exhaust gases, for example as powders or extrudates, or as washcoat on substrate

The metal oxide catalyst composition may be used as powders which generally have an average particle size of 1 to 100 microns (μm). The particle size of the metal oxide catalyst composition may be adjusted by crushing and/or sieving, for example.

The metal oxide catalyst composition may be used as extrudates, i.e., shaped bodies obtained by extrusion. The extrudates may have any suitable structures allowing exhaust gas flow through, preferably honeycomb structures. The honeycomb structures may have flow passages as described for the monolithic flow-through and wall-flow structures hereinbelow.

The metal oxide catalyst composition may be used as washcoat on substrate. The substrate generally refers to a structure that is suitable for withstanding conditions encountered in exhaust streams, on which the metal oxide catalyst composition is carried in the form of washcoat.

The substrate may be a monolithic flow-through structure, which has a plurality of fine, parallel gas flow passages extending from an inlet to an outlet face of the substrate such that passages are open to fluid flow therethrough. The passages, which are essentially straight paths from their fluid inlet to their fluid outlet, are defined by walls on which the catalytic material is applied as washcoats so that the gases flowing through the passages contact the catalytic material.

The substrate may alternatively be a monolithic wall-flow structure having a plurality of fine, parallel gas flow passages extending along from an inlet to an outlet face of the substrate wherein alternate passages are blocked at opposite ends. The passages are defined by walls on which the catalytic material is applied as washcoats so that the gases flowing through the passages contact the catalytic material. The configuration requires the gases flow through the porous walls of the wall-flow substrate to reach the outlet face.

The term “washcoat” has its usual meaning in the art and refers to a thin, adherent coating of a catalytic or other material applied to a substrate. A washcoat is generally formed by preparing a slurry containing the desired material and optionally processing aids such as binder with a certain solid content (e.g., 15 to 60% by weight) and then applying the slurry onto a substrate, dried and calcined to provide a washcoat.

Accordingly, in the fourth aspect, the present invention provides a catalytic article comprising the metal oxide catalyst composition according to the present invention.

In the fifth aspect, the present invention provides a system for treatment of exhaust gases, especially from an internal combustion engine, which comprises a reductant source, the catalytic article as described herein, and optionally one or more of diesel oxidation catalyst (DOC), three-way conversion catalyst (TWC), four-way conversion catalyst (FWC), non-catalyzed or catalyzed soot filter (CSF), ammonia oxidation catalyst (AMOx), NOx trap, NOx absorber catalyst, hydrocarbon trap catalyst, sensor and mixer.

The catalytic article according to the present invention may be located downstream of an internal combustion engine, such as a diesel engine, especially a heavy-duty diesel engine, in a close-coupled position, in a position downstream of the close-coupled position, or both. It is preferred that the catalytic article according to the present invention is located downstream of an internal combustion engine in a close-coupled position.

It is preferred that the exhaust gas treatment system further comprise a diesel oxidation catalyst located downstream of the engine and upstream of the catalytic article according to the present invention. In some embodiments, the exhaust gas treatment system preferably comprises both a diesel oxidation catalyst and a catalyzed soot filter located upstream of the catalytic article according to the present invention.

### EMBODIMENTS

Various embodiments are listed below. It will be understood that the embodiments listed below may be combined with all aspects and other embodiments in accordance with the scope of the invention.

1. A non-vanadium based metal oxide catalyst composition, which comprises
at least one metal oxide, comprising manganese oxide, and
a support, comprising particles of composite oxide of aluminum and at least one metal selected from cerium, manganese and titanium, wherein aluminum is present in the composite oxide in an amount of from 50% to 80% by weight, calculated as Al₂O₃, based on the total weight of the composite oxide,
wherein the at least one metal oxide is dispersed on the support, and
wherein manganese oxide is present in the metal oxide catalyst composition in an amount of from 2.5% to 10% by weight, calculated as MnO₂, based on the total weight of the metal oxide catalyst composition.

2. The non-vanadium based metal oxide catalyst composition according to embodiment 1, wherein the at least one metal oxide further comprises an oxide of titanium (Ti), iron (Fe), magnesium (Mg) or aluminum (Al), or any combinations thereof.

3. The non-vanadium based metal oxide catalyst composition according to embodiment 2, wherein each of the oxides of Ti, Fe, Mg and Al is present in an amount of no greater than 10% by weight, no greater than 8% by weight, or no greater than 6% by weight, calculated as respective oxides, based on the total weight of the metal oxide catalyst composition.

4. The non-vanadium based metal oxide catalyst composition according to any of preceding embodiments, wherein manganese oxide is present in an amount of 3% to 8% by weight calculated as MnO₂, based on the total weight of the metal oxide catalyst composition.

5. The non-vanadium based metal oxide catalyst composition according to any of preceding embodiments, wherein the at least one metal oxide further comprises titanium oxide, which is preferably present in an amount of 1 to 6% by weight, or 2 to 4% by weight calculated as TiO₂, based on the total weight of the catalyst composition.

6. The non-vanadium based metal oxide catalyst composition according to any of preceding embodiments, wherein the at least one metal oxide further comprises iron oxide, which is preferably present in an amount of 1 to 5% by weight, or 3 to 5% by weight calculated as Fe₂O₃, based on the total weight of the metal oxide catalyst composition.

7. The non-vanadium based metal oxide catalyst composition according to any of preceding embodiments, wherein the support comprises the particles of composite oxide and a dopant selected from Ti, Si, Zr, La and Ba, which dopant is preferably present in an amount of 1 to 10% by weight, or 3 to 6% by weight calculated as respective oxides, based on the total weight of the metal oxide catalyst composition.

8. The non-vanadium based metal oxide catalyst composition according to any of preceding embodiments, wherein the support comprises particles of composite oxide of aluminum, cerium and optionally manganese and/or titanium.

9. The non-vanadium based metal oxide catalyst composition according to embodiment 7, wherein the support consists of particles of composite oxide of aluminum and cerium, and optionally the dopant.

10. The non-vanadium based metal oxide catalyst composition according to embodiment 8or 9, wherein cerium is present in the composite oxide in an amount of 20% to 50% by weight, 20% to 40% by weight, or 20% to 30% by weight, calculated as CeO₂, based on the total weight of the composite oxide.

11. The non-vanadium based metal oxide catalyst composition according to embodiment 10, the composite oxide of aluminum and cerium comprises a phase of Al₂O₃ and a phase of CeO₂ with a crystallite size of at least 5 nm, preferably at least 9 nm, at least 9.5 nm or at least 10 nm, as determined by XRD analysis in fresh state.

12. The non-vanadium based metal oxide catalyst composition according to any of preceding embodiments, which further comprises a coating metal oxide, for example titanium oxide, aluminum oxide, silicon oxide, magnesium oxide, zirconium oxide or any combinations thereof.

13. A process for preparing the non-vanadium based metal oxide catalyst composition as defined in any of preceding embodiments, which comprises a step of impregnating one or more precursors of the at least one metal oxide onto the support and then optionally a step of impregnating one or more precursors of the coating metal oxide.

14. The process according to embodiment 13, wherein the impregnating one or more precursors of the at least one metal oxide onto support is carried out in a water-soluble alcohol solvent.

15. The process according to embodiment 13 or 14, wherein the water-soluble alcohol solvent is selected from methanol, ethanol, n-propanol and iso-propanol.

16. The process according to any of embodiments 13 to 15, which further comprises a step of impregnating one or more precursors of a dopant onto the particles of composite oxide, preferably in a water-soluble alcohol solvent, before the impregnating one or more precursors of the at least one metal oxide.

17. A method for treatment of exhaust gases containing nitrogen oxides by selective catalytic reduction, which comprises contacting the exhaust gas with the metal oxide catalyst composition as defined in any of embodiments 1 to 12, in the presence of a reductant.

18. The method according to embodiment 17, wherein the exhaust gas originates from internal combustion engines, for example diesel engines, especially heavy-duty diesel engines.

19. A catalytic article comprising the metal oxide catalyst composition as defined in any of embodiments 1 to 12, for example in form of powders or extrudates, or in form of washcoat on substrate.

20. The catalytic article according to embodiment 19, wherein the substrate is a monolithic flow-through structure or monolithic wall-flow structure.

21. A system for treatment of exhaust gases, especially from an internal combustion engine, which comprises a reductant source, the catalytic article according to embodiments 19 or 20, and optionally one or more of diesel oxidation catalyst (DOC), three-way conversion catalyst (TWC), four-way conversion catalyst (FWC), non-catalyzed or catalyzed soot filter (CSF), ammonia oxidation catalyst (AMOx), NOx trap, NOx absorber catalyst, hydrocarbon trap catalyst, sensor and mixer.

22. The system according to embodiment 21, wherein the catalytic article is located downstream of an internal combustion engine, such as a diesel engine, especially a heavy- duty diesel engine, in a close-coupled position, in a position downstream of the close-coupled position, or both, preferably in a close-coupled position.

The invention will be further illustrated by following Examples, which set forth particularly advantageous embodiments. While the Examples are provided to illustrate the present invention, they are not intended to limit it.

### EXAMPLES

### I. Preparation Examples

### Example 1—Preparation of a vanadium based metal oxide catalyst (3V@8W-TiO₂)

0.1909 g of ammonium metatungstate was dissolved in 30 ml of deionized water and stirred evenly, to which 2 g of TiO₂ in anatase form was added and stirred for 1 h. The obtained solution was transferred to a rotary evaporator and dried at 60° C. Then the obtained product was calcined in muffle furnace at 500° C. for 3 h with a ramping rate of 2° C./min, to provide a WO₃ modified TiO₂ support.

0.0867 g of NH₄VO₃ was dissolved in a solution of 0.5 g of oxalic acid in 30 ml of deionized water. Then the WO₃ modified TiO₂ support as obtained above was added in the solution and stirred for 1 h. The mixed solution was transferred to a rotary evaporator and dried at 60° C.

Then the obtained product was calcined in muffle furnace at 500° C. for 3 h with a ramping rate of 2° C./min.

### Example 2—Preparation of non-vanadium based metal oxide catalysts with alumina support (MnCeTi@Al)

Certain amount of γ-Al₂O₃ support was firstly prepared in a 25 ml crucible. Calculated amounts of Ce(NO₃)₃·6H₂O and Mn (NO₃)₂·4H₂O were dissolved in 1.44 ml absolute ethanol under ultrasound for 10 seconds in a 5 ml beaker. Calculated amount of tetrabutyl titante was then added in the solution. This solution was then added to the crucible with the γ-Al₂O₃support under stirring to reach incipient wetness state. The mixture in the crucible was dried in an oven at 80° C. for 2 h and calcined at 500° C. with a heating rate of 2° C./min for 3 h. The calcined powder was naturally cooled down to room temperature to obtain the catalyst. The formulations for different samples were listed in Table 1 below.

TABLE 1

| Sample | | | Tetrabutyl | Supports, |
|---|---|---|---|---|
| Designation* | Ce(NO₃)₃•6H₂O, g | Mn(NO₃)₃•4H₂O, g | titante, ml | g |
| 10% MnCeTi@Al | 0.1262 | 0.0952 | 0.072 | 0.9 |
| 20% MnCeTi@Al | 0.2524 | 0.1904 | 0.144 | 0.8 |
| 30% MnCeTi@Al | 0.3786 | 0.2856 | 0.216 | 0.7 |

*% refers to the amount of Mn, Ce and Ti in total (wt %), calculated as respective oxides, based on the total weight of the catalyst.

### Example 3—Preparation of non-vanadium based metal oxide catalysts (Mn@AlCe, MnTi@AlCe)

Certain amount of a composite oxide of aluminum and cerium (AlCe10, AlCe20, AlCe30 or AlCe50) as the support was put into a crucible. Calculated amount of Mn(NO₃)₂·4H₂O was dissolved in 1.44 ml absolute ethanol in a 5 ml beaker under ultrasound for 10 seconds. In the case that titanium was also supported, calculated amount of tetrabutyl titante was added in the solution above. A solution for impregnation was thus provided.

The solution for impregnation was added to the crucible with the support under stirring to reach incipient wetness state. The mixture in the crucible was dried in an oven at 80° C. for 2 h. The dried powder was heated to 500° C. at a rate of 2° C./min and hold for 3 h to obtain calcined powder. The calcined powder was naturally cooled down to room temperature to obtain the catalyst. The formulations for different samples were listed in Table 2 below.

### Example 4—Preparation of a non-vanadium based metal oxide catalyst in water (7Mn@AlCe20 (H₂O))

A catalyst sample was prepared in the same manner as described in Example 3, except that absolute ethanol was replaced with the same amount of deionized water.

### Example 5—Preparation of a non-vanadium based metal oxide catalyst with Ti modified support (8Mn@Ti—AlCe20)

Certain amount of a composite oxide of aluminum and cerium (AlCe20) as the support was put into the crucible. Calculated amount of tetrabutyl titante was dissolved in 1.44 ml absolute ethanol under ultrasound until transparent. This solution was then added to the crucible with AlCe20 under stirring to reach incipient wetness state. The mixture in the crucible was dried in an oven at 80° C. for 2 h to obtain the Ti modified AlCe20 support. Then, calculated amount of Mn(NO₃)₂·4H₂O was dissolved in 1.44 ml absolute ethanol in a 5 ml beaker under ultrasound for 10 seconds. This solution was then added to the crucible with the support under stirring to reach incipient wetness state. The powder was heated to 500° C. at a rate of 2° C./min and hold for 3 h to obtain calcined powder. The calcined powder was naturally cooled down to room temperature to obtain the catalyst. The formula of the sample was also listed in Table 2 below.

TABLE 2

| Sample | | Tetrabutyl | |
|---|---|---|---|
| Designation* | Mn(NO₃)₃•4H₂O, g | titante, ml | Supports, g |
| 3Mn2Ti@AlCe20 | 0.086 | 0.085 | 0.95 |
| 3.5Mn2Ti@AlCe20 | 0.095 | 0.072 | 0.9 |
| 4Mn@AlCe20 | 0.106 | — | 0.9 |
| 5Mn@AlCe20 | 0.144 | — | 0.95 |
| 5Mn2.5Ti@AlCe20 | 0.144 | 0.174 | 0.925 |
| 6Mn@AlCe20 | 0.173 | — | 0.94 |
| 6Mn3Ti@AlCe20 | 0.173 | 0.106 | 0.91 |
| 6.5Mn3.3Ti@AlCe20 | 0.191 | 0.144 | 0.9 |
| 6.5Mn3.3Ti@AlCe30 | 0.191 | 0.144 | 0.9 |
| 6.5Mn3.3Ti@AlCe50 | 0.191 | 0.144 | 0.9 |
| 7Mn@AlCe20 | 0.202 | — | 0.93 |
| 7Mn@AlCe20 | 0.202 | — | 0.93 |
| (H₂O)** | | | |
| 7Mn@AlCe30 | 0.202 | — | 0.93 |
| 7Mn@AlCe50 | 0.202 | — | 0.93 |
| 7Mn3.5Ti@AlCe20 | 0.202 | 0.149 | 0.895 |
| 7.5Mn@AlCe20 | 0.212 | — | 0.9 |
| 8Mn@AlCe10 | 0.23 | — | 0.92 |
| 8Mn@AlCe20 | 0.23 | — | 0.92 |
| 8Mn4Ti@AlCe10 | 0.231 | 0.17 | 0.88 |
| 8Mn4Ti@AlCe20 | 0.231 | 0.17 | 0.88 |
| 8Mn@4Ti—AlCe20 | 0.231 | 0.17 | 0.88 |
| 10Mn@AlCe20 | 0.288 | — | 0.9 |
| 20Mn@AlCe20 | 0.577 | — | 0.8 |

*The numbers before Mn and Ti represent the amounts thereof (wt %), calculated as respective oxides, based on the total weight of the catalyst; the number after Ce represents the amount thereof (wt %), calculated as CeO₂, based on the weight of the composite oxide of Al and Ce.
**“(H₂O)” refers to the solvent for the synthesis

### Example 6—Preparation of non-vanadium based metal oxide catalysts (5Fe6.5Mn3.3Ti@AlCe20, 5Fe7Mn@AlCe20)

Certain amount of AlCe20 as the support was put into a crucible. Calculated amount of Mn(NO₃)2·4H₂O and Fe(NO₃)₃·9H₂O was dissolved in 1.44 ml absolute ethanol in a 5ml beaker under ultrasound for 10 seconds. In the case that titanium was also supported, calculated amount of tetrabutyl titante was added in the solution above. A solution for impregnation was thus provided.

The solution for impregnation was added to the crucible with AlCe20 support under stirring to reach incipient wetness state. The mixture in crucible was dried at 80° C. in an oven for 2 h. The dried powder was heated to 500° C. at a rate of 2° C./min and hold for 3 h to obtain calcined powder. Then calcined powder was naturally cooled down to room temperature to obtain the catalyst. The formulations for different samples were listed in Table 3 below.

TABLE 3

| | | Tetrabutyl | Fe(NO₃)₃•9H₂O, | Support, |
|---|---|---|---|---|
| Sample Designation* | Mn(NO₃)₃•4H₂O, g | titante, ml | g | g |
| 5Fe6.5Mn3.3Ti@AlCe20 | 0.191 | 0.144 | 0.2663 | 0.9 |
| 5Fe7Mn@AlCe20 | 0.202 | — | 0.2663 | 0.93 |

*The numbers before Fe, Mn and Ti represent the amounts thereof (wt %), calculated as respective oxides, based on the total weight of the catalyst; the number after Ce represents the amount thereof (wt %), calculated as CeO₂, based on the weight of the composite oxide of Al and Ce.

### Example 7—Preparation of TiO2 coated metal oxide catalysts (TiO₂ coated 7Mn@AlCe20, Al₂O₃ coated 7Mn@AlCe20)

1 g of catalyst 7Mn@AlCe20 was firstly prepared in the same manner as described in Example 1.

Certain amount of Diisopropyl bis (triethanolamine) titanate (M=466.4) or aluminum isopropoxide was dissolved in 1.44 ml absolute ethanol under ultrasound until transparent. This solution was then added to a crucible with the catalyst 7Mn@AlCe20 under stirring to reach incipient wetness state. The mixture in the crucible was dried in an oven at 80° C. for 2 h. The dried powder was heated to 500° C. at a rate of 2° C./min and hold for 3 h to obtain calcined powder. Then the calcined powder was naturally cooled down to room temperature to obtain the catalyst with a coating. The formulations for different samples were listed in Table 4 below.

### Example 8—Preparation of SiO₂ coated metal oxide catalysts (SiO₂ coated 7Mn@AlCe20)

1 g of the catalyst 7Mn@/AlCe20 catalyst as prepared in the same manner as described in Example 1 was dispersed into 100 ml deionized water, and then adjusted to pH 8 with ammonium hydroxide. When the solution was heated at 70° C., certain amount of tetraethyl orthosilicate was added under intensely stirring for 1h. After that, the formed precipitate was separated and washed with 1 L deionized water until pH is 7. The wet mixture was dried in an oven at 80° C. for 2 h. The dried powder was heated to 500° C. at a rate of 2° C./min and hold for 3 h to obtain calcined powder. Then the calcined powder was naturally cooled down to room temperature to obtain the catalyst with a coating. The formulations for different samples were also listed in Table 4 below.

TABLE 4

| | 7Mn@AlCe20, | |
|---|---|---|
| Sample Designation* | g | Coating precursors |
| TiO₂ coated 7Mn@AlCe20 | 1 | 108.7 μL Diisopropyl bis |
| (Mn:Ti = 3:1) | | (triethanolamine) titanate |
| TiO₂ coated 7Mn@AlCe20 | 1 | 187.6 μL Diisopropyl bis |
| (Mn:Ti = 2:1) | | (triethanolamine) titanate |
| Al₂O₃ coated 7Mn@AlCe20 | 1 | 0.033 g aluminum |
| (Mn:Al = 5:1) | | isopropoxide |
| Al₂O₃ coated 7Mn@AlCe20 | 1 | 0.055 g aluminum |
| (Mn:Al = 3:1) | | isopropoxide |
| SiO₂ coated 7Mn@AlCe20 | 1 | 36.0 μL tetraethyl |
| (Mn:Si = 5:1) | | orthosilicate |
| SiO₂ coated 7Mn@AlCe20 | 1 | 60.0 μL tetraethyl |
| (Mn:Si = 3:1) | | orthosilicate |

*The ratio in brackets refers to molar ratio

### Example 9—Preparation of MgO coated metal oxide catalysts (MgO coated 7Mn@AlCe20)

1 g of catalyst 7Mn@AlCe20 was firstly prepared in the same manner as described in Example 1. 0.1908 g Mg(NO₃)₂·4H₂O was dissolved in 1.44 ml absolute ethanol in a 5 ml beaker under ultrasound for 10 seconds. This solution was added to a crucible with the catalyst 7Mn@AlCe20 under stirring to reach incipient wetness state. The mixture in the crucible was dried in an oven at 80° C. for 2 h. The dried powder was heated to 500° C. at a rate of 2° C./min and hold for 3 h to obtain calcined powder. The calcined powder was naturally cooled down to room temperature to obtain the catalyst.

### Example 10—Preparation of a Non-Vanadium Based Metal Oxide Catalyst Based on a Composite Oxide of Al and Ce With High Ce Content (10Mn@AlCe52)

A composite oxide of Al and Ce was prepared in accordance with Example 1 in CN106824173A. The obtained composite oxide AlCe52 was impregnated with Mn(NO₃)₂·4H₂O in the same manner as described in Example 3.

### II. SCR Performance Measurement

### II. 1 General Procedure

SCR performance measurements were performed using a fixed-bed quartz flow reactor (Inner diameter=4 mm). The reactor was filled with 0.15 g of a catalyst sample of 40-60 meshes (about 250 to 400 μm) and particles of cordierite as a diluent to a total length of 32 mm. The measurements were carried out in the temperature range of from 90 to 480° C.

The gas feed consists of 500 vppm NO, 500 vppm NH₃, 10 vol % O₂, 5 vol % H₂O, 5 vol % CO₂, and the balance of N₂. The total flow rate was controlled to 475 mL/min, corresponding to a gas hourly space velocity (GHSV) of 150 000 h⁻¹. The GHSV calculated by catalyst volume was fixed with the assistant of cordierite to make the volume of all catalysts to be the same.

The gas concentrations of NO, NO₂, NH₃, H₂O, and N₂O were simultaneously monitored by an FTIR spectrometer (Thermo Fisher). The SCR catalytic activity was recorded after the reaction system reached a steady state. The NO conversion was calculated in accordance with the following equation

$$NO conversion ( \% ) = \frac{{[ NO ]}_{in} - {[ NO ]}_{out}}{{[ NO ]}_{in}} \times 100 \%$$

wherein [NO]ᵢₙ and [NO]ₒᵤₜ indicate inlet and outlet NO concentrations, respectively.

Catalyst aging condition: Air with 10% H₂O, 650° C. for 50 h.

Sulfation condition: 0.15 g catalyst of 40-60 meshes was filled into a fixed-bed quartz flow reactor (Inner diameter=4 mm). The sulfation process was conducted at a temperature of 300° C. The gas feed consists of 40 vppm SO₂, 10 vol % O₂, 5 vol % H₂O, 5 vol % CO₂, and the balance of N2. The total flow rate was controlled to 235 mL·min^{31 1}, corresponding to a gas hourly space velocity (GHSV) of 75,000 h⁻¹.

Desulfation condition: The desulfation process was conducted at a temperature of 600° C. with 475 mL/min N₂ as the balance gas for 3 h. The total flow rate was controlled to 475 mL·min⁻¹, corresponding to a gas hourly space velocity (GHSV) of 150,000 h⁻¹.

### II. 2 Test results

The test results were summarized in following Tables.

TABLE 5
Summary of NO conversions of aged samples

| | 120° | 150° | 180° | 210° |
|---|---|---|---|---|
| Samples | C., % | C., % | C., % | C., % |
| 3V@8W—TiO₂ | 0.81 | 2.40 | 7.79 | 19.90 |
| 10% MnCeTi@Al | 11.01 | 19.39 | 30.64 | 50.18 |
| 20% MnCeTi@Al | 14.15 | 25.95 | 40.67 | 56.57 |
| 30% MnCeTi@Al | n.a. | n.a. | n.a. | n.a. |
| 3Mn2Ti@AlCe20 | 15.88 | 26.90 | 37.16 | 49.20 |
| 3.5Mn2Ti@AlCe20 | 26.53 | 28.79 | 40.93 | 60.34 |
| 4Mn@AlCe20 | 20.27 | 29.31 | 42.68 | 62.21 |
| 5Mn@AlCe20 | 19.06 | 32.82 | 48.61 | 76.38 |
| 5Mn2.5Ti@AlCe20 | 24.21 | 38.48 | 53.03 | 75.94 |
| 6Mn@AlCe20 | 24.62 | 39.26 | 59.32 | 82.70 |
| 6Mn3Ti@AlCe20 | 22.46 | 38.85 | 56.02 | 79.80 |
| 6.5Mn3.3Ti@AlCe20 | 24.76 | 42.03 | 64.60 | 85.20 |
| 6.5Mn3.3Ti@AlCe30 | 20.93 | 34.82 | 45.93 | 58.32 |
| 6.5Mn3.3Ti@AlCe50 | 19.96 | 33.91 | 48.64 | 72.87 |
| 7Mn@AlCe20 | 32.51 | 49.85 | 73.61 | 88.71 |
| 7Mn@AlCe20 (H₂O) | 19.52 | 32.96 | 47.94 | 74.23 |
| 7Mn@AlCe30 | 18.36 | 30.68 | 39.45 | 54.29 |
| 7Mn@AlCe50 | 16.71 | 27.02 | 41.64 | 61.68 |
| 7Mn3.5Ti@AlCe20 | 25.15 | 41.48 | 59.70 | 86.50 |
| 7.5Mn@AlCe20 | 21.13 | 40.18 | 71.75 | 86.31 |
| 8Mn@AlCe10 | 21.28 | 36.84 | 49.61 | 70.92 |
| 8Mn@AlCe20 | 25.06 | 41.15 | 57.59 | 82.59 |
| 8Mn4Ti@AlCe10 | 24.11 | 38.90 | 51.13 | 74.66 |
| 8Mn4Ti@AlCe20 | 32.98 | 45.64 | 73.73 | 88.74 |
| 8Mn@4Ti—AlCe20 | 20.50 | 35.55 | 54.90 | 79.92 |
| 10Mn@AlCe20 | 54.43 | 84.45 | 93.38 | 97.85 |
| 20Mn@AlCe20 | 58.90 | 87.51 | 96.15 | 98.83 |
| 10Mn@AlCe52 | 24.24 | 41.69 | 58.72 | 78.57 |
| 5Fe6.5Mn3.3Ti@AlCe20 | 33.09 | 44.05 | 61.15 | 86.06 |
| 5Fe7Mn@AlCe20 | 18.80 | 39.15 | 58.72 | 80.62 |
| TiO₂ coated 7Mn@AlCe20 | 26.59 | 40.99 | 55.69 | 77.12 |
| (Mn:Ti = 3:1) | | | | |
| TiO₂ coated 7Mn@AlCe20 | 24.54 | 38.73 | 51.13 | 71.15 |
| (Mn:Ti = 2:1) | | | | |
| Al₂O₃ coated 7Mn@AlCe20 | 20.21 | 33.45 | 47.75 | 65.83 |
| (Mn:Al = 5:1) | | | | |
| Al₂O₃ coated 7Mn@AlCe20 | 23.14 | 35.39 | 47.28 | 64.78 |
| (Mn:Al = 3:1) | | | | |
| SiO₂ coated 7Mn@AlCe20 | 15.53 | 25.75 | 36.74 | 57.22 |
| (Mn:Si = 5:1) | | | | |
| SiO₂ coated 7Mn@AlCe20 | 12.92 | 22.06 | 32.64 | 50.13 |
| (Mn:Si = 3:1) | | | | |
| MgO coated 7Mn@AlCe20 | 25.72 | 40.72 | 61.44 | 86.72 |

As can be seen from the results, the catalysts according to the present invention exhibit higher NO conversions than the conventional vanadium-based catalysts and the catalysts having a composition not according to the present invention, at a temperature of 210° C. or lower.

TABLE 6
NO conversion comparison between fresh and aged samples

| | Fresh | | | | Aged | | | |
|---|---|---|---|---|---|---|---|---|
| | 120° | 150° | 180° | 210° | 120° | 150° | 180° | 210° |
| Samples | C., % | C., % | C., % | C., % | C., % | C., % | C., % | C., % |
| 6.5Mn3.3Ti@AlCe20 | 44.99 | 54.24 | 79.46 | 93.77 | 24.76 | 42.03 | 64.60 | 85.20 |
| 7Mn@AlCe20 | 34.04 | 53.36 | 85.95 | 94.65 | 32.51 | 49.85 | 73.61 | 88.71 |
| 7.5Mn@AlCe20 | 34.04 | 53.36 | 85.95 | 94.65 | 21.13 | 40.18 | 71.75 | 86.31 |
| 10Mn@AlCe20 | 78.41 | 89.19 | 90.88 | 97.83 | 54.43 | 84.45 | 93.38 | 97.85 |
| 20Mn@AlCe20 | 35.14 | 62.73 | 90.84 | 93.74 | 58.90 | 87.51 | 96.15 | 98.83 |
| TiO₂ coated 7Mn@AlCe20 | 14.60 | 23.45 | 41.42 | 74.32 | 24.54 | 38.73 | 51.13 | 71.15 |
| (Mn:Ti = 2:1) | | | | | | | | |
| Al₂O₃ coated 7Mn@AlCe20 | 11.01 | 21.73 | 39.62 | 70.97 | 23.14 | 35.39 | 47.28 | 64.78 |
| (Mn:Al = 3:1) | | | | | | | | |
| MgO coated 7Mn@AlCe20 | 6.81 | 12.92 | 25.12 | 41.79 | 25.72 | 40.72 | 61.44 | 86.72 |

TABLE 7
N₂O formation comparison between fresh and aged samples

| | Fresh | | | | Aged | | | |
|---|---|---|---|---|---|---|---|---|
| | 120° C., | 150° C., | 180° C., | 210° C., | 120° C., | 150° C., | 180° C., | 210° C., |
| Samples | ppm | ppm | ppm | ppm | ppm | ppm | ppm | ppm |
| 7Mn@AlCe20 | n.a. | n.a. | n.a. | n.a. | 5.12 | 9.44 | 21.00 | 42.82 |
| 10Mn@AlCe20 | 21.15 | 48.55 | 51.79 | 89.58 | 10.40 | 24.76 | 72.19 | 121.31 |
| 20Mn@AlCe20 | 22.27 | 63.86 | 118.90 | 125.58 | 15.34 | 53.45 | 114.00 | 182.02 |

As can be seen from the results, the catalysts according to the present invention have desirable thermal stability without significant activity reduction upon aging. The catalysts with coating even exhibit improved activity upon aging.

TABLE 8
NO conversions at 210° C. upon sulfurization and desulfurization

| | Upon | Upon |
|---|---|---|
| Samples | sulfurization, % | desulfurization, % |
| 6.5Mn3.3Ti@AlCe20 | 0.60 | n.a. |
| 5Fe6.5Mn3.3Ti@AlCe20 | 8.10 | n.a. |
| 7Mn@AlCe20 | 5.87 | 15.68 |
| 5Fe7Mn@AlCe20 | 17.91 | n.a. |
| TiO₂ coated 7Mn@AlCe20 | 5.78 | 18.72 |
| (Mn:Ti = 2:1) | | |
| Al₂O₃ coated 7Mn@AlCe20 | 6.83 | 12.18 |
| (Mn:Al = 3:1) | | |
| MgO coated 7Mn@AlCe20 | 5.19 | 17.78 |

### III. Characterization of Composite Oxides as Support

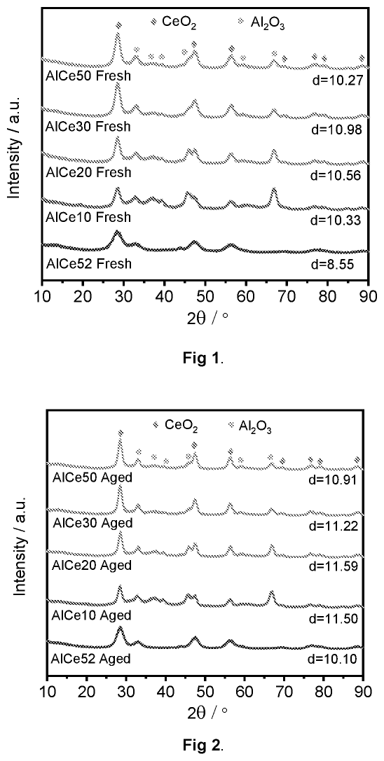

The composite oxides as the supports in the catalysts as described above were characterized by XRD. The patterns of each sample were shown in FIG. 1 and FIG. 2, wherein the d values indicated for each sample correspond to 2θ=28.5°. The composite oxides and the CeO₂ crystallite sizes of each sample obtained from XRD patterns were summarized in Table 9 below.

The composite oxides were also characterized for surface area by the BET method, pore volume and pore size by the BJH method. The measurements were also summarized in Table 9 below.

TABLE 9

| | Crystallite | | | |
|---|---|---|---|---|
| | size of CeO₂ | S_{BET} | Pore volume | Pore size |
| Supports | (nm) | (m²/g) | (cm³/g) | (nm) |
| AlCe10 Fresh | 10.33 | 131.3 | 1.12 | 33.1 |
| AlCe20 Fresh | 10.56 | 128.6 | 1.04 | 32.2 |
| AlCe30 Fresh | 10.98 | 169.1 | 0.88 | 20.7 |
| AlCe50 Fresh | 10.27 | 81.1 | 0.82 | 40.4 |
| AlCe52 Fresh | 8.55 | 213.6 | 0.29 | 5.5 |
| AlCe10 Aged* | 11.50 | 124.7 | 1.03 | 33.0 |
| AlCe20 Aged* | 11.59 | 92.6 | 1.02 | 44.2 |
| AlCe30 Aged* | 11.22 | 136.2 | 0.81 | 23.7 |
| AlCe50 Aged* | 10.91 | 72.2 | 0.84 | 46.5 |
| AlCe52 Aged* | 10.10 | 153.8 | 0.27 | 6.9 |

*Aging: air with 10% H₂O, 650° C. for 50 h

The composite oxides as the support all show increased crystallite size upon aging. The less the crystallite size increases, the higher stability the composite oxide exhibits. It can be seen that the composite oxides having at least 50% aluminum (calculated as Al₂O₃) as used in the catalysts according to the present invention exhibit higher hydrothermal stability than the composite oxide AlCe52.

Although the invention herein has been described with reference to particular embodiments and examples, it is to be understood that these embodiments and examples are merely illustrative of the principles and applications of the present invention. It will be apparent to those skilled in the art that various modifications and variations can be made to the composition and process of the present invention without departing from the spirit and scope of the invention. Thus, it is intended that the present invention include modifications and variations that are within the scope of the appended claims and their equivalents.

1. A non-vanadium based metal oxide catalyst composition, which comprises.
at least one metal oxide, comprising manganese oxide; and,
a support, comprising particles of composite oxide of aluminum and at least one metal selected from cerium, manganese and titanium, wherein aluminum is present in the composite oxide in an amount of from 50% to 80% by weight, calculated as Al₂O₃, based on the total weight of the composite oxide,
wherein the at least one metal oxide is dispersed on the support; and.
wherein manganese oxide is present in the metal oxide catalyst composition in an amount of from 2.5% to 10% by weight, calculated as MnO₂, based on the total weight of the metal oxide catalyst composition.

2. The non-vanadium based metal oxide catalyst composition according to claim 1, wherein the at least one metal oxide further comprises an oxide of titanium (Ti), iron (Fe), magnesium (Mg) or aluminum (Al), or any combinations thereof.

3. The non-vanadium based metal oxide catalyst composition according to claim 2, wherein each of the oxides of Ti, Fe, Mg and Al is present in an amount of no greater than 10% by weight, no greater than 8% by weight, or no greater than 6% by weight, calculated as respective oxides, based on the total weight of the metal oxide catalyst composition.

4. The non-vanadium based metal oxide catalyst composition according to claim 1, wherein manganese oxide is present in an amount of 3% to 8% by weight calculated as MnO₂, based on the total weight of the metal oxide catalyst composition.

5. The non-vanadium based metal oxide catalyst composition according to claim 1, wherein the at least one metal oxide further comprises titanium oxide, which is preferably present in an amount of 1 to 6% by weight, or 2 to 4% by weight calculated as TiO₂, based on the total weight of the catalyst composition.

6. The non-vanadium based metal oxide catalyst composition according to claim 1, wherein the at least one metal oxide further comprises iron oxide, which is preferably present in an amount of 1 to 5% by weight, or 3 to 5% by weight calculated as Fe203, based on the total weight of the metal oxide catalyst composition.

7. The non-vanadium based metal oxide catalyst composition according to claim 1, wherein the support comprises the particles of composite oxide and a dopant selected from Ti, Si, Zr, La and Ba, which dopant is preferably present in an amount of 1 to 10% by weight, or 3 to 6% by weight calculated as respective oxides, based on the total weight of the metal oxide catalyst composition.

8. The non-vanadium based metal oxide catalyst composition according to claim 1, wherein the support comprises particles of composite oxide of aluminum, cerium and optionally manganese and/or titanium.

9. The non-vanadium based metal oxide catalyst composition according to claim 7, wherein the support consists of particles of composite oxide of aluminum and cerium, and optionally the dopant.

10. The non-vanadium based metal oxide catalyst composition according to claim 8, wherein cerium is present in the composite oxide in an amount of 20% to 50% by weight, 20% to 40% by weight, or 20% to 30% by weight, calculated as CeO₂, based on the total weight of the composite oxide.

11. The non-vanadium based metal oxide catalyst composition according to claim 10, the composite oxide of aluminum and cerium comprises a phase of Al₂O₃ and a phase of CeO₂ with a crystallite size of at least 5 nm, preferably at least 9 nm, at least 9.5 nm or at least 10 nm, as determined by XRD analysis in fresh state.

12. The non-vanadium based metal oxide catalyst composition according to claim 1, which further comprises a coating metal oxide, for example titanium oxide, aluminum oxide, silicon oxide, magnesium oxide, zirconium oxide or any combinations thereof.

13. A process for preparing the non-vanadium based metal oxide catalyst composition as defined in claim 1, which comprises a step of impregnating one or more precursors of the at least one metal oxide onto the support and then optionally a step of impregnating one or more precursors of the coating metal oxide.

14. The process according to claim 13, wherein the impregnating one or more precursors of the at least one metal oxide onto support is carried out in a water-soluble alcohol solvent, wherein the water-soluble alcohol solvent is selected from methanol, ethanol, n-propanol and iso-propanol.

15. (canceled)

16. The process according to claim 13, which further comprises a step of impregnating one or more precursors of a dopant onto the particles of composite oxide, preferably in a water-soluble alcohol solvent, before the impregnating one or more precursors of the at least one metal oxide.

17. A method for treatment of exhaust gases containing nitrogen oxides by selective catalytic reduction, which comprises contacting the exhaust gas with the metal oxide catalyst composition as defined in claim 1, in the presence of a reductant.

18. The method according to claim 17, wherein the exhaust gas originates from internal combustion engines, for example diesel engines, especially heavy-duty diesel engines.

19. A catalytic article comprising the metal oxide catalyst composition as defined in claim 1, for example in form of powders or extrudates, or in form of washcoat on substrate, wherein the substrate is a monolithic flow-through structure or monolithic wall-flow structure.

20. (canceled)

21. A system for treatment of exhaust gases, especially from an internal combustion engine, which comprises a reductant source, the catalytic article according to claim 19, and optionally one or more of diesel oxidation catalyst (DOC), three-way conversion catalyst (TWC), four-way conversion catalyst (FWC), non-catalyzed or catalyzed soot filter (CSF), ammonia oxidation catalyst (AMOx), NOx trap, NOx absorber catalyst, hydrocarbon trap catalyst, sensor and mixer.

22. The system according to claim 21, wherein the catalytic article is located downstream of an internal combustion engine, such as a diesel engine, especially a heavy-duty diesel engine, in a close-coupled position, in a position downstream of the close-coupled position, or both, preferably in a close-coupled position.
